(19) United States
(12) Patent Application Publication
(10) Pub. No.: US 2011/0116255 A1
(43) Pub. Date: May 19, 2011

(54) ILLUMINATING DEVICE AND DISPLAY DEVICE

(75) Inventor: Munetoshi Ueyama, Osaka-shi (JP)

(73) Assignee: SHARP KABUSHIKI KAISHA, Osaka-shi, Osaka (JP)

(21) Appl. No.: 13/003,018

(22) PCT Filed: Mar. 31, 2009
(86) PCT No.: PCT/JP2009/056632

§ 371 Date: Jan. 7, 2011

(30) Foreign Application Priority Data
Jul. 30, 2008 (JP) 2008-196218

(51) Int. Cl. G02F 1/13357; F21S 4/00

(52) U.S. Cl. 362/97.1; 362/225

(57) ABSTRACT

In an illuminating device (3) provided with a light-emitting face (15a) for emitting light, first cold cathode fluorescent tubes (discharge tubes) (20) and second cold cathode fluorescent tubes (discharge tubes) (21) sequentially provided in positions increasingly distant from the light-emitting face (15a) are installed, and these first and second cold cathode fluorescent tubes (20, 21) are set so as to have substantially the same light-emitting luminance as each other at the light-emitting face (15a).

### TECHNICAL FIELD

The present invention relates to an illuminating device, particularly an illuminating device that uses a discharge tube such as a cold cathode fluorescent tube, and a display device using the same.

### BACKGROUND ART

In recent years, display devices provided with a liquid crystal panel serving as a flat display unit having many features such as being thinner and lighter compared with a conventional cathode-ray tube, as typified by liquid crystal display devices, are becoming the mainstream of domestic television receivers, for example. Such liquid crystal display devices are provided with an illuminating device (backlight) that emits light, and a liquid crystal panel that displays a desired image by functioning as a shutter with respect to the light from a light source provided in the illuminating device. The television receivers display information such as characters and images included in video signals of television broadcasts on a display face of the liquid crystal panel.

Further, the above illuminating devices are broadly divided into direct type and edge light type depending on the arrangement of the light source with respect to the liquid crystal panel. The direct type illuminating device, which more easily achieves higher luminance and larger size than an edge light type device, is ordinarily used for liquid crystal display devices provided with a liquid crystal panel of 20-inches or larger. Specifically, a direct type illuminating device is constituted with a plurality of light sources disposed on the rear (non-display face) side of the liquid crystal panel, and since the light sources can be disposed directly behind the liquid crystal panel, many light sources can be used. Accordingly, higher luminance can be easily obtained, and thus such a direct type illuminating device is suitable for achieving higher luminance and larger size. Further, since the inside of the direct type illuminating device is a hollow structure, the device is light even when the size thereof is increased, and thus is suitable for achieving higher luminance and larger size.

Further, with the conventional direct type illuminating device as described above, it has been proposed that a plurality of cold cathode fluorescent tubes serving as light sources are provided below a diffusion plate with a predetermined separation dimension therebetween as disclosed in, for example, JP 2004-127643A. Further, it was assumed that this conventional illuminating device could achieve higher luminance while maintaining favorable light-emitting quality, by using a glass diffusion plate whose haze value is 95% or more and transmittance is 10% to 40%, and disposing the cold cathode fluorescent tubes such that the distance to the diffusion plate is 10 mm or less.

### DISCLOSURE OF INVENTION

### Problem to be Solved by the Invention

There is a demand for the conventional illuminating device as described above to achieve still higher luminance, following calls for a liquid crystal panel with higher definition and higher luminance.

However, with the conventional illuminating device as described above, since a plurality of cold cathode fluorescent tubes (discharge tubes) are provided with a predetermined separation dimension therebetween, there was a limit to the number of cold cathode fluorescent tubes that could be installed. Accordingly, with the conventional illuminating device, there was a problem in that it was difficult to achieve even higher luminance since the number of cold cathode fluorescent tubes to be installed could not be increased.

Further, with this conventional illuminating device, it was assumed that favorable light-emitting quality could be maintained by preventing an image of the cold cathode fluorescent tubes appearing on the light-emitting face of the diffusion plate by using the diffusion plate with a high haze value and comparatively low transmittance. However, there has been a problem in that using such a diffusion plate causes a drop in the utilization efficiency of light from the cold cathode fluorescent tubes, and thus higher luminance cannot be efficiently achieved.

In consideration of the above problems, it is an object of the present invention to provide an illuminating device that can prevent a drop in light-emitting quality and a drop in the utilization efficiency of light from discharge tubes while achieving higher luminance, and a display device using the same.

### Means for Solving Problem

In order to achieve the above object, an illuminating device according to the present invention is an illuminating device including a light-emitting face for emitting light; first to Nth (N is an integer of two or more) discharge tubes sequentially provided in positions increasingly distant from the light-emitting face are installed, and the first to Nth discharge tubes are set so as to have substantially the same light-emitting luminance as each other at the light-emitting face.

In the illuminating device constituted as described above, the first to Nth (N is an integer of two or more) discharge tubes are sequentially provided in positions increasingly distant from the light-emitting face. Further, the first to Nth discharge tubes are set so as to have substantially the same light-emitting luminance as each other at the light-emitting face. Accordingly, unlike the above conventional example, it is possible to prevent a drop in light-emitting quality and a drop in the utilization efficiency of light from the discharge tubes, while achieving higher luminance.

Note that substantially the same light-emitting luminance as each other herein means that the light-emitting luminance of light from each of the first to Nth discharge tubes is adjusted such that the difference in luminance therebetween is in a range of 10% or less.

Further, in the above illuminating device, it is preferable that the first to Nth discharge tubes are set so as to have higher light-emitting luminance the further the distance from the light-emitting face.

In this case, it is possible to easily make the light-emitting luminance of the first to Nth discharge tubes at the light-emitting face substantially the same.

Further, in the above illuminating device, supply current to the first to Nth discharge tubes may increase the further the distance from the light-emitting face.

In this case, the supply current to the first to Nth discharge tubes sequentially increases in this stated order, and thus the light-emitting amount increases the further the distance from the light-emitting face. Accordingly, it is possible to easily make the light-emitting luminance of the first to Nth discharge tubes at the light-emitting face substantially the same as each other.

Further, in the above illuminating device, the diameter of the first to Nth discharge tubes may decrease the further the distance from the light-emitting face.

In this case, the first to Nth discharge tubes are sequentially selected in the stated order in descending order of diameter, and thus the light-emitting amount per unit surface area increases the further the distance from the light-emitting face. Accordingly, it is possible to easily make the light-emitting luminance of the first to Nth discharge tubes at the light-emitting face substantially the same as each other.

Further, in the above illuminating device, each of the first to Nth discharge tubes may include a plurality of discharge tubes that are provided on the same plane with a predetermined separation dimension therebetween.

In this case, higher luminance can be easily achieved, and it is possible to reliably prevent two adjacent discharge tubes from coming into contact with each other due to vibrations or the like.

Further, in the above illuminating device, each of the first to Nth discharge tubes may include a discharge tube having a plurality of straight tube portions that are linearly formed and provided in parallel to each other, and a bent portion that is provided so as to be continuous with the straight tube portions and bent relative to the straight tube portions.

In this case, since discharge tubes each having a plurality of straight tube portions are used, the number of discharge tubes to be installed can be reduced.

Further, in the above illuminating device, the first to Nth discharge tubes may be installed so as to intersect each other.

In this case, it is possible to easily and reliably prevent luminance unevenness appearing on the light-emitting face, and thus light-emitting quality can be easily improved.

Further, the above illuminating device may include a diffusion plate that is provided above the first to Nth discharge tubes and diffuses light from the first to Nth discharge tubes, and the light-emitting face may be constituted by a light-emitting face of the diffusion plate.

In this case, a drop in light-emitting quality can be easily prevented.

Further, a display device of the present invention uses any of the above illuminating devices.

Since the display device constituted as described above uses the illuminating device that can prevent a drop in light-emitting quality and a drop in the utilization efficiency of light from the discharge tubes while achieving higher luminance, it is possible to easily constitute a display device with high luminance and high performance.

### Effects of the Invention

According to the present invention, it is possible to provide an illuminating device that can prevent a drop in light-emitting quality and a drop in the utilization efficiency of light from the discharge tubes while achieving higher luminance, and a display device using the same.

### BRIEF DESCRIPTION OF DRAWINGS

FIG. 1 is a schematic cross-sectional view illustrating an illuminating device and a liquid crystal display device according to a first embodiment of the present invention.

FIG. 2 is a diagram illustrating the configuration of a main part of the above illuminating device.

FIG. 3 is a diagram illustrating an example of a configuration of CCFL drive circuits shown in FIG. 2.

FIG. 4 is a schematic cross-sectional view illustrating an illuminating device and a liquid crystal display device according to a second embodiment of the present invention.

FIG. 5 is a diagram illustrating the configuration of a main part of the illuminating device shown in FIG. 4.

FIG. 6 is a schematic cross-sectional view illustrating an illuminating device and a liquid crystal display device according to a third embodiment of the present invention.

FIG. 7 is a diagram illustrating the configuration of a main part of the illuminating device shown in FIG. 6.

FIG. 8 is a schematic cross-sectional view illustrating an illuminating device and a liquid crystal display device according to a fourth embodiment of the present invention.

FIG. 9 is a diagram illustrating the configuration of a main part of the illuminating device shown in FIG. 8.

### DESCRIPTION OF THE INVENTION

Hereinafter, preferred embodiments of an illuminating device of the present invention and a display device using the same are described with reference to the drawings. Note that in the following description, the case where the present invention is applied to a transmission type liquid crystal display device is described as an example. Further, the dimensions of constituent members in the diagrams do not faithfully represent the actual dimensions of the constituent members, the dimensional ratios of the constituent members, or the like.

### First Embodiment

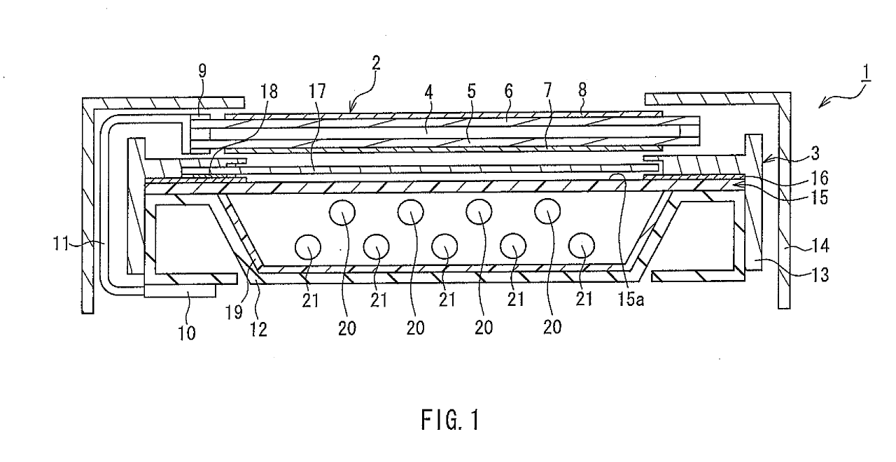

FIG. 1 is a schematic cross-sectional view illustrating an illuminating device and a liquid crystal display device according to a first embodiment of the present invention. In FIG. 1, a liquid crystal display device 1 according to the present embodiment is provided with a liquid crystal panel 2 serving as a display unit installed such that the upper side in FIG. 1 is the viewing side (display face side), and an illuminating device 3 of the present invention that is disposed on the non-display face side (lower side in FIG. 1) of the liquid crystal panel 2 and generates illumination light with which the liquid crystal panel 2 is illuminated.

The liquid crystal panel 2 is provided with a liquid crystal layer 4, a pair of transparent substrates 5 and 6 that sandwich the liquid crystal layer 4, and polarizing plates 7 and 8 respectively provided on the outer surface of the transparent substrates 5 and 6. Further, the liquid crystal panel 2 is provided with a driver 9 for driving the liquid crystal panel 2, and a drive circuit 10 connected to the driver 9 via a flexible printed circuit board 11. The liquid crystal panel 2 is configured so as to be capable of driving the liquid crystal layer 4 in pixel units. In the liquid crystal panel 2, a polarization state of the above illumination light that has entered via the polarizing plate 7 is modulated by the liquid crystal layer 4, and the amount of light that passes through the polarizing plate 8 is controlled, thereby displaying a desired image.

The illuminating device 3 is provided with a closed-end chassis 12 with an opening on the upper side in FIG. 1 (the liquid crystal panel 2 side) and a frame-shaped frame 13 installed on the liquid crystal panel 2 side of the chassis 12. The chassis 12 constitutes a casing that houses cold cathode fluorescent tubes (discharge tubes) that will be described later. Further, the chassis 12 and the frame 13 are constituted, for example, by metal, and sandwiched by a bezel 14 having an L-shaped cross section in a state where the liquid crystal panel 2 is installed above the frame 13. Accordingly, the illuminating device 3 is attached to the liquid crystal panel 2, and integrated as the transmission type liquid crystal display device 1 in which illumination light from the illuminating device 3 enters the liquid crystal panel 2.

Further, the illuminating device 3 is provided with a diffusion plate 15 installed so as to cover the opening portion of the chassis 12, an optical sheet 17 installed on the liquid crystal panel 2 side above the diffusion plate 15, and a reflective sheet 19 provided on the inner face of the chassis 12. Further, in the illuminating device 3, a plurality of, for example, four cold cathode fluorescent tubes 20 are arranged in parallel to each other as first discharge tubes below the diffusion plate 15, and furthermore, a plurality of, for example, five cold cathode fluorescent tubes 21 are arranged in parallel to each other as second discharge tubes below the cold cathode fluorescent tubes 20. As described in detail later, supply currents different from each other are caused to flow through the cold cathode fluorescent tubes 20 and 21, and the cold cathode fluorescent tubes 20 and 21 are set so as to have substantially the same light-emitting luminance at a light-emitting face 15a of the diffusion plate 15. With the illuminating device 3, light from the cold cathode fluorescent tubes 20 and 21 is emitted toward the liquid crystal panel 2 as the above illumination light.

The diffusion plate 15 is constituted using, for example, a rectangular synthetic resin or glass material having a thickness of approximately 2 mm, and diffuses light from the cold cathode fluorescent tubes 20 and 21 (including the light reflected by the reflective sheet 19) so as to allow the diffused light to be emitted to the optical sheet 17 side. Further, the four sides of the diffusion plate 15 are placed on a frame-shaped surface provided on the upper side of the chassis 12, and the diffusion plate 15 is incorporated inside the illuminating device 3 in the state of being sandwiched between that surface of the chassis 12 and the inner face of the frame 13 with an elastically deformable pressing member 16 interposed. Furthermore, the substantially center portion of the diffusion plate 15 is supported by a transparent support member (not shown) installed on the reflective sheet 19, which prevents the diffusion plate 15 from flexing toward the inside of the chassis 12.

Further, the diffusion plate 15 is held so as to be movable between the chassis 12 and the pressing member 16, and even when expansion and contraction (plasticity) deformation occurs in the diffusion plate 15 due to the influence of heat such as heat generated by the cold cathode fluorescent tubes 20 and 21 or a rise of the temperature of the inside of the chassis 12, such plastic deformation is absorbed by elastic deformation of the pressing member 16, thereby preventing a drop in the diffusibility of light from the cold cathode fluorescent tubes 20 and 21 as much as possible. Further, the case of using the diffusion plate 15 made of a glass material having a higher thermal resistance compared with a synthetic resin is more preferable in that warping, yellowing, heat deformation, or the like due to the above mentioned influence of heat is unlikely to occur.

The optical sheet 17 includes, for example, a diffusion sheet constituted by a synthetic resin film having a thickness of approximately 0.5 mm, and is configured so as to improve the display quality at the display face of the liquid crystal panel 2 by appropriately diffusing the above illumination light emitted toward the liquid crystal panel 2. Further, in the optical sheet 17, a known optical sheet material such as a prism sheet or a polarizing sheet for improving the display quality at the display face of the liquid crystal panel 2 is appropriately laminated when necessary. The optical sheet 17 is configured so as to convert light exiting from the diffusion plate 15 into sheet-like light that has predetermined luminance (for example, 10000 cd/m²) or higher and almost uniform luminance, and cause the converted light to be incident on the liquid crystal panel 2 side as illumination light. Note that in addition to the above description, for example, an optical member such as a diffusion sheet for adjusting the viewing angle of the liquid crystal panel 2 may be appropriately laminated on the upper side of the liquid crystal panel 2 (display face side).

Further, on the optical sheet 17, a projecting portion projecting toward the left side in FIG. 1 is formed in a center portion of the left edge side in the diagram, which is the upper side when the liquid crystal display device 1 is actually used, for example. With the optical sheet 17, only the above projecting portion is held sandwiched between the inner face of the frame 13 and the pressing member 16 with an elastic material 18 interposed, and the optical sheet 17 is incorporated inside the illuminating device 3 in the state of being able to expand and contract. Accordingly, the optical sheet 17 is constituted such that the occurrence of wrinkling, flexing, or the like in the optical sheet 17 is prevented as much as possible by being able to freely deform by expanding and contracting on the basis of the above projecting portion, even when expansion or contraction (plasticity) deformation occurs due to the above mentioned influence of heat such as heat generated by the cold cathode fluorescent tubes 20 and 21. As a result, in the liquid crystal display device 1, it is possible to prevent a drop in display quality such as luminance unevenness, which is caused by flexing of the optical sheet 17 and the like, from occurring on the display face of the liquid crystal panel 2 as much as possible.

The reflective sheet 19 is constituted by a metallic thin film with high light reflectance such as an aluminum or silver film having a thickness of approximately 0.2 to 0.5 mm, for example, and functions as a reflective plate that reflects light from the cold cathode fluorescent tubes 20 and 21 toward the diffusion plate 15. Accordingly, in the illuminating device 3, by efficiently reflecting light emitted from the cold cathode fluorescent tubes 20 and 21 to the diffusion plate 15 side, the utilization efficiency of the light and the luminance at the diffusion plate 15 can be increased. Note that in addition to this description, instead of the above metallic thin film, the inner face of the chassis 12 can also function as a reflective plate by using a reflective sheet material made of a synthetic resin or applying, for example, a white coating or the like with a high light reflectance to that inner face thereof.

Fluorescent lamp type tubes having a straight tube shape are used for the cold cathode fluorescent tubes 20 and 21, and electrode portions (not shown) provided at the both ends of the tubes are supported outside the chassis 12. Further, thinned tubes having, for example, a diameter of 4.0 mm and excellent light-emitting efficiency are used for the cold cathode fluorescent tubes 20 and 21, and the cold cathode fluorescent tubes 20 and 21 are held inside the chassis 12 by light source holders (not shown) in the state where the distance to each of the diffusion plate 15 and the reflective sheet 19 is maintained at a predetermined distance. Furthermore, the cold cathode fluorescent tubes 20 and 21 are disposed such that the long direction thereof is parallel to the direction orthogonal to the direction in which gravity acts. Accordingly, with the cold cathode fluorescent tubes 20 and 21, mercury (vapor) enclosed inside thereof is prevented from gathering on one end portion side in the long direction due to the action of gravity, thereby significantly extending the lamp life.

Further, the cold cathode fluorescent tubes 20 are installed such that the lamp centers thereof are disposed on the same plane. Further, with regard to the cold cathode fluorescent tubes 20, the distance between the plane where the lamp centers thereof are disposed and the light-emitting face 15a (reference face) of the diffusion plate 15 is set to 8 mm, for example. Moreover, the cold cathode fluorescent tubes 20 are equidistantly arranged at a regular interval (pitch) dimension (for example, 4 mm) in the orthogonal direction (horizontal direction in FIG. 1) orthogonal to the long direction thereof.

Similarly, the cold cathode fluorescent tubes 21 are installed such that the lamp centers thereof are disposed on the same plane. Further, with regard to the cold cathode fluorescent tubes 21, the distance between the plane where the lamp centers thereof are disposed and the light-emitting face 15a (reference face) of the diffusion plate 15 is set to 15 mm, for example. Furthermore, the cold cathode fluorescent tubes 21 are equidistantly arranged at a regular interval (pitch) dimension (for example, 4 mm) in the orthogonal direction (horizontal direction in FIG. 1) orthogonal to the long direction thereof.

Further, the cold cathode fluorescent tubes 20 and 21 are disposed such that they do not overlap with each other in the vertical direction in FIG. 1. Specifically, each cold cathode fluorescent tube 20 is provided so as to be disposed between two adjacent cold cathode fluorescent tubes 21. Similarly, each cold cathode fluorescent tube 21 is provided so as to be disposed between two adjacent cold cathode fluorescent tubes 20.

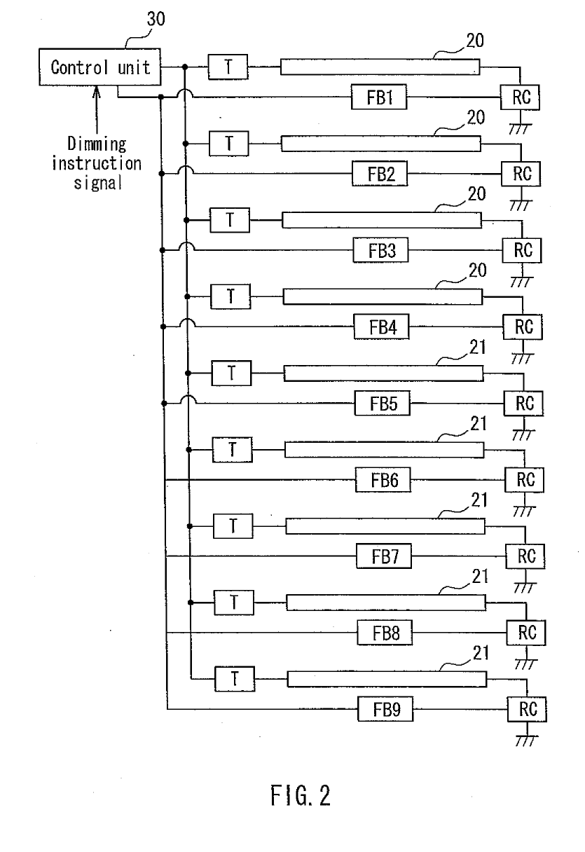

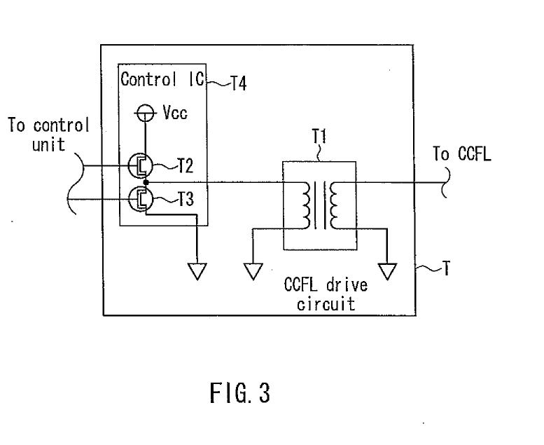

Here, with reference to FIGS. 2 and 3, the configuration of a main part of the illuminating device 3 according to the present embodiment is specifically described.

FIG. 2 is a diagram illustrating the configuration of a main part of the above illuminating device, and FIG. 3 is a diagram illustrating an example of a configuration of CCFL drive circuits shown in FIG. 2.

As shown in FIG. 2, in the illuminating device 3, a control unit 30 for performing drive control of the plurality of cold cathode fluorescent tubes 20 and 21, and CCFL drive circuits T that are provided one per cold cathode fluorescent tube 20 and 21, and drive and light the corresponding cold cathode fluorescent tube 20 or 21 based on a driving signal from the control unit 30 are installed. The CCFL drive circuits T are installed on one end portion side in the long direction of the cold cathode fluorescent tubes 20 and 21, and configured so as to supply current from the above one end portion side to the corresponding cold cathode fluorescent tubes 20 and 21. Further, an inverter circuit described later is used for each of the CCFL drive circuits T, and the CCFL drive circuits T are configured so as to be capable of driving the corresponding cold cathode fluorescent tubes 20 and 21 using PWM dimming, based on the above driving signal.

Furthermore, the illuminating device 3 is provided with lamp current detection circuits RC that are provided one per cold cathode fluorescent tube 20 and 21, and detect a value of lamp current that has flowed through the corresponding cold cathode fluorescent tube 20 or 21, and in the illuminating device 3, the lamp current values detected by the lamp current detection circuits RC are outputted to the control unit 30 via feedback circuits FB1, FB2, FB3, FB4, FB5, FB6, FB7, FB8, and FB9 installed corresponding to the cold cathode fluorescent tubes 20 and 21.

Further, for example, a dimming instruction signal for changing the luminance at the light-emitting face of the illuminating device 3 is inputted to the control unit 30 as an instruction signal from the outside, and the liquid crystal display device 1 is configured such that a user can appropriately change the luminance (brightness) at the display face of the liquid crystal panel 2. Specifically, the liquid crystal display device 1 is configured such that a dimming instruction signal is inputted to the control unit 30 from, for example, an operation input device (not shown) such as a remote controller provided on the liquid crystal display device 1 side. The control unit 30 determines the duty ratio of PWM dimming using the inputted dimming instruction signal, and determines target values of the supply current to the cold cathode fluorescent tubes 20 and 21.

Further, at this time, in the illuminating device 3 according to the present embodiment, the control unit 30 determines target values of the supply current to the cold cathode fluorescent tubes 20 and 21 such that supply current increases the further the distance from the light-emitting face 15a. Specifically, in the illuminating device 3 according to the present embodiment, the cold cathode fluorescent tubes 20 and 21 are set so as to have higher light-emitting luminance the further the distance from the light-emitting face 15a, and the control unit 30 determines the target values of the supply current to the cold cathode fluorescent tubes 20 and 21 such that light-emitting luminance thereof at the light-emitting face 15a is substantially the same as each other.

After that, the control unit 30 generates and outputs a driving signal to each of the CCFL drive circuits T based on the determined target values, and accordingly the values of lamp current that flows through the corresponding cold cathode fluorescent tubes 20 and 21 change. As a result, the amount of light emitted by the cold cathode fluorescent tubes 20 and 21 changes according to the dimming instruction signal, and thus the luminance at the light-emitting face of the illuminating device 3 and the luminance at the display face of the liquid crystal panel 2 are appropriately changed according to an operation instruction from the user.

Further, the values of the lamp current actually supplied to the cold cathode fluorescent tubes 20 and 21 are fed back to the control unit 30 as detected current values via the corresponding lamp current detection circuits RC and the corresponding feedback circuits FB1 to FB9. The control unit 30 executes feedback control using the detected current values and the target values of the supply current determined based on the above dimming instruction signal, thereby maintaining display at the luminance desired by the user.

Further, as illustrated in FIG. 3, an inverter circuit provided with a transformer T1, transistors T2 and T3 that are connected to the control unit 30 and provided on the primary winding side of the transformer T1, and a power source VCC connected to the transistor T2 is used for the CCFL drive circuit T, and the CCFL drive circuit T performs high frequency lighting of the connected cold cathode fluorescent tube 20 or 21. Specifically, a high voltage side terminal of either the cold cathode fluorescent tube 20 or 21 is connected to the secondary winding of the transformer T1, and the transistors T2 and T3 perform switching operation based on a driving signal from the control unit 30, and thereby the transformer T1 supplies power from the power source VCC to the corresponding cold cathode fluorescent tube 20 or 21 so as to light the cold cathode fluorescent tube 20 or 21.

Further, in the CCFL drive circuit T, for example, the power source VCC and the transistors T2 and T3 that are each constituted using an FET are configured as one control IC T4. In the CCFL drive circuit T, the transformer T1 and the control IC T4 are implemented on an inverter circuit substrate (not shown).

In the illuminating device 3 according to the present embodiment constituted as described above, the cold cathode fluorescent tubes (first discharge tubes) 20 and the cold cathode fluorescent tubes (second discharge tubes) 21 are sequentially provided in positions increasingly distant from the light-emitting face 15a of the diffusion plate 15. Further, the cold cathode fluorescent tubes 20 and 21 are set so as to have substantially the same light-emitting luminance as each other at the light-emitting face 15a. Accordingly, unlike the above conventional example, the illuminating device 3 according to the present embodiment can prevent a drop in light-emitting quality and a drop in the utilization efficiency of light from the cold cathode fluorescent tubes 20 and 21, while achieving higher luminance.

Further, in the illuminating device 3 according to the present embodiment, supply current to the cold cathode fluorescent tubes 20 and 21 sequentially increases in this stated order, and thus the light-emitting amount increases the further the distance from the light-emitting face 15a. Accordingly, with the illuminating device 3 according to the present embodiment, it is possible to easily make the light-emitting luminance of the cold cathode fluorescent tubes 20 and 21 at the light-emitting face 15a substantially the same as each other.

Further, in the illuminating device 3 according to the present embodiment, the four cold cathode fluorescent tubes 20 are provided on the same plane with a predetermined separation dimension therebetween, and the five cold cathode fluorescent tubes 21 are provided on the same plane with a predetermined separation dimension therebetween. Accordingly, the illuminating device 3 according to the present embodiment can easily achieve higher luminance, and with regard to the cold cathode fluorescent tubes 20 and 21, it is possible to reliably prevent two adjacent cold cathode fluorescent tubes 20 and 21 from coming into contact with each other due to vibrations or the like.

Further, in the present embodiment, since the illuminating device 3 that can prevent a drop in light-emitting quality and a drop in the utilization efficiency of light from the cold cathode fluorescent tubes 20 and 21 while achieving higher luminance is used, it is possible to easily constitute the liquid crystal display device 1 with high luminance and high performance.

### Second Embodiment

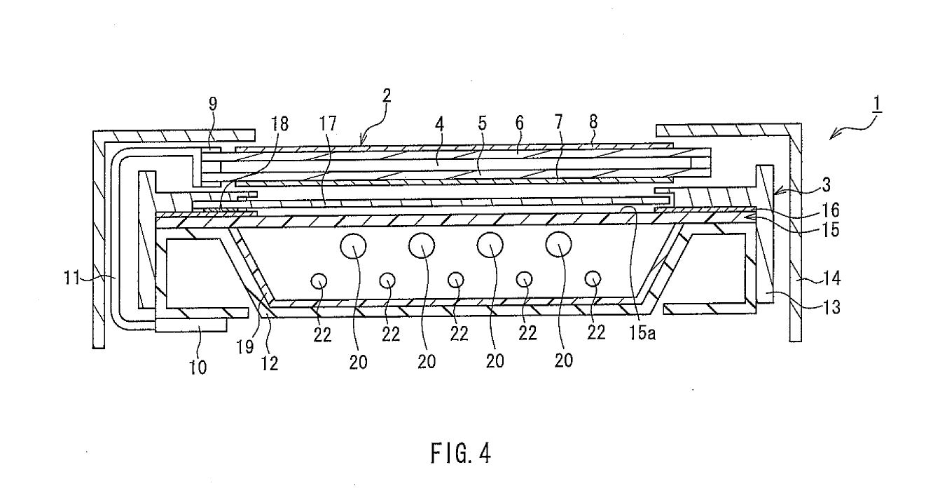

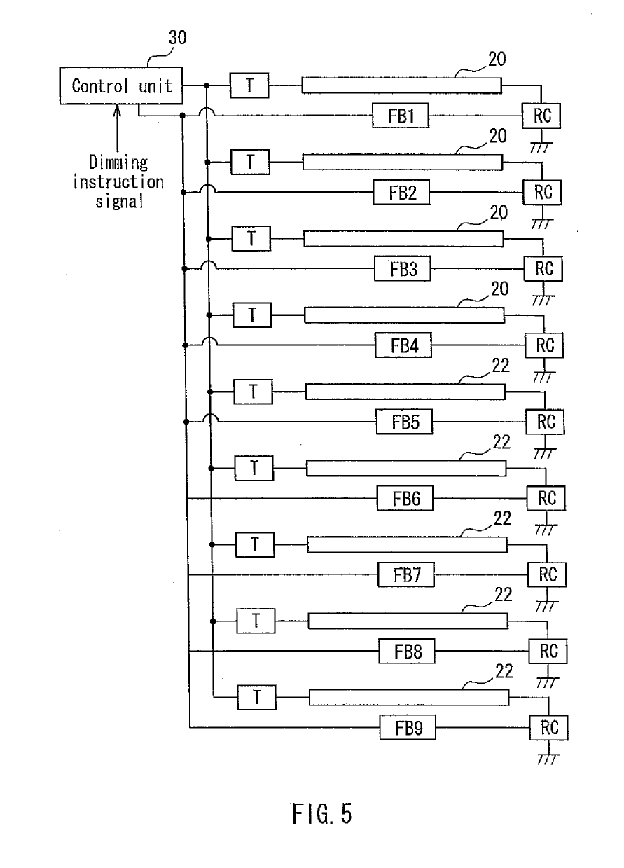

FIG. 4 is a schematic cross-sectional view illustrating an illuminating device and a liquid crystal display device according to a second embodiment of the present invention, and FIG. 5 is a diagram illustrating the configuration of a main part of the illuminating device shown in FIG. 4. In the diagrams, the main difference between the present embodiment and the first embodiment described above is that the diameter of the cold cathode fluorescent tubes decreases the further the distance from the light-emitting face. Note that the same numerals are given to the elements in common with the elements in the above first embodiment, and redundant description thereof is omitted.

Specifically, in the illuminating device 3 according to the present embodiment, a plurality of, for example, five cold cathode fluorescent tubes 22 are used as second discharge tubes as shown in FIG. 4. With these cold cathode fluorescent tubes 22, tubes having a smaller diameter compared with that of the cold cathode fluorescent tubes (first discharge tubes) 20 such as, for example, thinned tubes having a diameter of 3.0 mm and excellent light-emitting efficiency, are used. That is, in the illuminating device 3 according to the present embodiment, settings are set such that the light-emitting luminance is higher the further the distance from the light-emitting face 15a, and the cold cathode fluorescent tubes 20 and 22 are installed such that the diameter thereof decreases the further the distance from the light-emitting face 15a of the diffusion plate 15.

Further, the cold cathode fluorescent tubes 22 are installed such that the lamp centers thereof are disposed on the same plane. Further, with regard to the cold cathode fluorescent tubes 22, the distance between the plane where the lamp centers thereof are disposed and the light-emitting face 15a (reference face) of the diffusion plate 15 is set to 15 mm, for example. Moreover, the cold cathode fluorescent tubes 22 are equidistantly arranged at a regular interval (pitch) dimension (for example, 4 mm) in the orthogonal direction (horizontal direction in FIG. 4) orthogonal to the long direction thereof.

Further, the cold cathode fluorescent tubes 20 and 22 are disposed such that they do not overlap with each other in the vertical direction in FIG. 4. Specifically, each cold cathode fluorescent tube 20 is provided so as to be disposed between two adjacent cold cathode fluorescent tubes 22. Similarly, each cold cathode fluorescent tube 22 is provided so as to be disposed between two adjacent cold cathode fluorescent tubes 20.

Further, as shown in FIG. 5, in the illuminating device 3 according to the present embodiment, the control unit 30 for performing drive control of the plurality of cold cathode fluorescent tubes 20 and 22, and the CCFL drive circuits T that are provided one per cold cathode fluorescent tube 20 and 22, and drive and light the corresponding cold cathode fluorescent tube 20 or 22 based on a driving signal from the control unit 30 are installed, as with the case of the first embodiment. Moreover, in the illuminating device 3 according to the present embodiment, as with the case of the first embodiment, for the cold cathode fluorescent tubes 20 and 22, the lamp current detection circuits RC are respectively provided, and the feedback circuits FB1 to FB9 are respectively installed, and the cold cathode fluorescent tubes 20 and 22 are driven to be lit using feedback control.

Note that in the illuminating device 3 according to the present embodiment, the control unit 30 is configured so as to determine target values such that the same supply current is caused to flow through the cold cathode fluorescent tubes 20 and 22 when the duty ratio of PWM dimming is determined using an inputted dimming instruction signal, which differs from the first embodiment.

With the above configuration, the illuminating device 3 according to the present embodiment can achieve the same operations/effects as those in the first embodiment. Further, with the illuminating device 3 according to the present embodiment, the cold cathode fluorescent tubes (first and second discharge tubes) 20 and 22 are selected in the stated order in descending order of diameter, and thus the light-emitting amount per unit surface area is greater the further the distance from the light-emitting face 15a. Accordingly, with the illuminating device 3 according to the present embodiment, it is possible to easily make the light-emitting luminance of the cold cathode fluorescent tubes 20 and 22 at the light-emitting face 15a substantially the same as each other.

### Third Embodiment

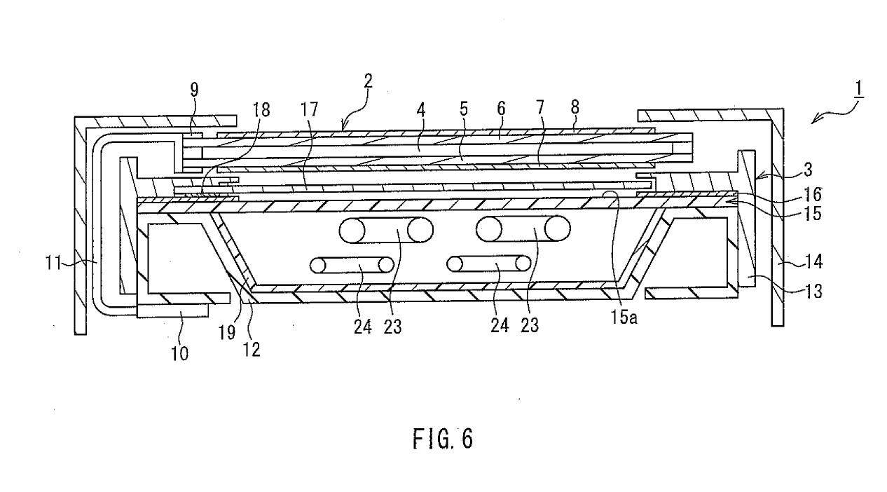

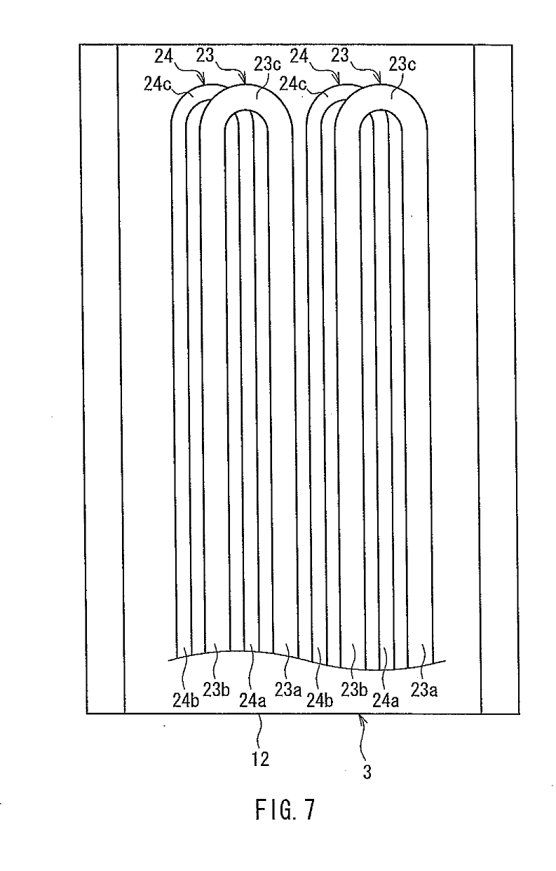

FIG. 6 is a schematic cross-sectional view illustrating an illuminating device and a liquid crystal display device according to a third embodiment of the present invention, and FIG. 7 is a diagram illustrating the configuration of a main part of the illuminating device shown in FIG. 6. In the diagrams, the main difference between the present embodiment and the second embodiment described above is that U tubes are used each having a pair of straight tube portions that are linearly formed and parallel to each other, and a bent portion that is provided between these straight tube portions so as to be continuous with the straight tube portions and bent relative to the straight tube portions. Note that the elements in common with those in the above second embodiment are given the same numerals, and redundant description thereof is omitted.

Specifically, as shown in FIGS. 6 and 7, in the illuminating device 3 according to the present embodiment, a plurality of, for example, two U tubes 23 are used as first discharge tubes, and a plurality of, for example, two U tubes 24 are used as second discharge tubes. Thinned tubes having, for example, a diameter of 4.0 mm and excellent light-emitting efficiency are used for the U tubes 23, and the U tubes 23 each have a pair of straight tube portions 23a and 23b that are parallel to each other, and a bent portion 23c provided between these straight tube portions 23a and 23b. Further, thinned tubes having, for example, a diameter of 3.0 mm and excellent light-emitting efficiency are used for the U tubes 24, and the U tubes 24 each have a pair of straight tube portions 24a and 24b that are parallel to each other, and a bent portion 24c provided between these straight tube portions 24a and 24b.

Further, the U tubes 23 are installed such that the lamp centers thereof are disposed on the same plane. Further, with regard to the U tubes 23, the distance between the plane where the lamp centers thereof are disposed and the light-emitting face 15a (reference face) of the diffusion plate 15 is set to 8 mm, for example. Moreover, the U tubes 23 are equidistantly arranged at a regular interval (pitch) dimension (for example, 4 mm) in the orthogonal direction (horizontal direction in FIG. 6) orthogonal to the long direction thereof.

Similarly, the U tubes 24 are installed such that the lamp centers thereof are disposed on the same plane. Further, with regard to the U tubes 24, the distance between the plane where the lamp centers thereof are disposed and the light-emitting face 15a (reference face) of the diffusion plate 15 is set to 15 mm, for example. Moreover, the U tubes 24 are equidistantly arranged at a regular interval (pitch) dimension (for example, 4 mm) in the orthogonal direction (horizontal direction in FIG. 6) orthogonal to the long direction thereof.

Further, the U tubes 23 and 24 are disposed such that the straight tube portions 23a, 23b, 24a, and 24b do not overlap with each other in the vertical direction in FIG. 6. Specifically, the U tubes 23 are provided such that both the straight tube portions 23a and 23b are disposed between the straight tube portions 24a and 24b. Similarly, the U tubes 24 are provided such that both the straight tube portions 24a and 24b are disposed between the straight tube portions 23a and 23b.

With the above configuration, the illuminating device 3 according to the present embodiment can achieve the same operations/effects as those in the second embodiment. Further, in the illuminating device 3 according to the present embodiment, since the U tubes (first discharge tubes) 23 each having the plurality of straight tube portions 23a and 23b, and the U tubes (second discharge tubes) 24 each having the plurality of straight tube portions 24a and 24b are used, the number of discharge tubes to be installed can be reduced. Moreover, it is possible to easily achieve simplification of the assembly operation of the illuminating device 3 and also to reduce the number of electrode portions of the discharge tubes, thereby enabling the illuminating device 3 in which generation of heat is suppressed to be easily configured.

### Fourth Embodiment

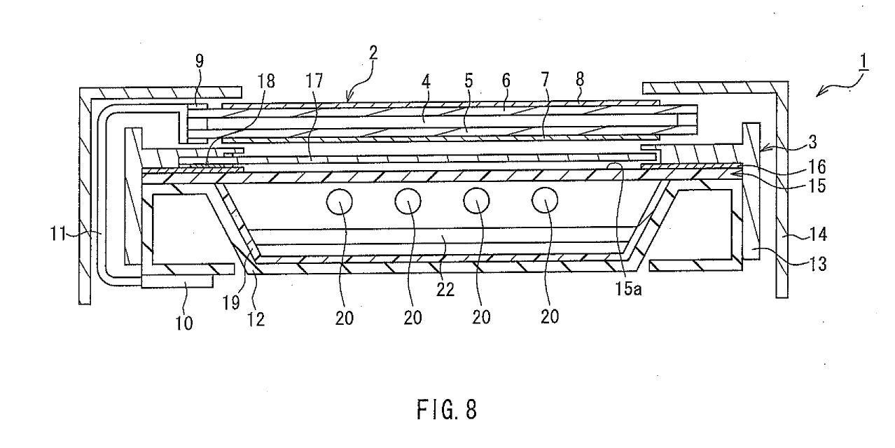

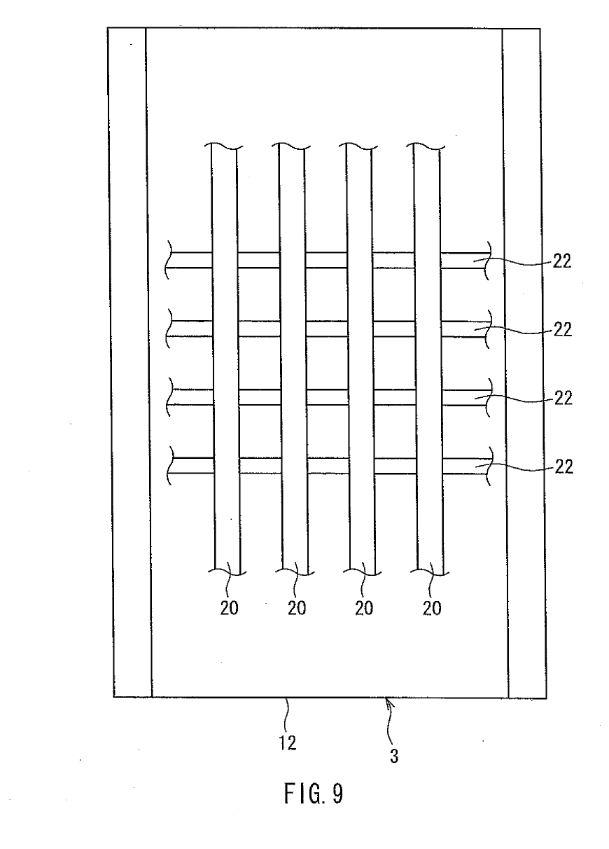

FIG. 8 is a schematic cross-sectional view illustrating an illuminating device and a liquid crystal display device according to a fourth embodiment of the present invention, and FIG. 9 is a diagram illustrating the configuration of a main part of the illuminating device shown in FIG. 8. In the diagrams, the main difference between the present embodiment and the second embodiment described above is that cold cathode fluorescent tubes (first discharge tubes) closer to the light-emitting face and cold cathode fluorescent tubes (second discharge tubes) further from the light-emitting face are installed so as to be orthogonal to each other. Note that the elements in common with those in the above second embodiment are given the same numerals, and redundant description thereof is omitted.

Specifically, as shown in FIGS. 8 and 9, in the illuminating device 3 according to the present embodiment, the cold cathode fluorescent tubes 20 and the cold cathode fluorescent tubes 22 are installed so as to be orthogonal to each other. Specifically, as illustrated in FIG. 9, the cold cathode fluorescent tubes 20 are provided so as to be parallel to the long direction (horizontal direction in the diagram) of the chassis 12, and the cold cathode fluorescent tubes 22 are provided so as to be parallel to the short direction (vertical direction in the diagram) of the chassis 12.

With the above configuration, the illuminating device 3 according to the present embodiment can achieve the same operations/effects as those in the second embodiment. Further, in the illuminating device 3 according to the present embodiment, since the cold cathode fluorescent tubes (first discharge tubes) 20 and the cold cathode fluorescent tubes 22 (second discharge tubes) are installed so as to be orthogonal to each other, it is possible to easily and reliably prevent luminance unevenness appearing on the light-emitting face 15a, and thus light-emitting quality can be easily improved.

Note that all the embodiments described above are illustrative and are not restrictive. The technical scope of the present invention is specified by the appended claims, and the configurations described therein and all modifications within the range of equivalency are also included in the technical scope of the present invention.

For example, in the above description, although the case where the present invention is applied to a transmission type liquid crystal display device is described, the illuminating device of the present invention is not limited to this, and is applicable to various display devices provided with a non-light-emitting type display unit for displaying information such as images and characters utilizing light from light sources. Specifically, the illuminating device of the present invention can be suitably used in a semi-transmissive type liquid crystal display device or a projection type display device using a liquid crystal panel for a light valve.

Further, in addition to the above description, the present invention can be suitably used as an illumination device in an X-ray film illuminator for irradiating roentgenograms with light, a light box for irradiating photographic negatives or the like with light to facilitate viewing, a light emitting device for illuminating billboards, advertisements provided on, for instance, station walls, or the like.

Further, although the configuration having the first and second discharge tubes provided in two vertical levels relative to the light-emitting face has been described in the above description, it is sufficient if the present invention is a device in which first to Nth (N is an integer of two or more) discharge tubes sequentially provided in positions increasingly distant from the light-emitting face are installed, and the first to Nth discharge tubes are set so as to have substantially the same light-emitting luminance as each other at the light-emitting face, and the device may have a configuration in which a plurality of discharge tubes are provided in three or more vertical levels relative to the light-emitting face.

Further, although the case where a diffusion plate is provided, and settings are set such that the light-emitting luminance at the light-emitting face of the diffusion plate is substantially the same as each other has been described in the above description, the present invention is not limited to this, and a configuration may be adopted in which for example, the opening face of the chassis, the light-emitting face of the optical sheet, or the like is used as the light-emitting face of the illuminating device, and settings are set such that the light-emitting luminance at that light-emitting face is substantially the same as each other. That is, according to the present invention, unlike the above conventional example, regardless of the presence or absence of a diffusion plate or characteristics thereof, it is possible to prevent a drop in light-emitting quality and to reliably prevent a drop in the utilization efficiency of light from the discharge tubes.

However, as in the above embodiments, the case where the diffusion plate is provided above the first and second discharge tubes is more preferable in that a drop in light-emitting quality can be easily prevented. Further, as in the above embodiments, the case where the first to Nth discharge tubes are set so as to have higher light-emitting luminance the further the distance from the light-emitting face is more preferable in that light-emitting luminance of the first to Nth discharge tubes at the light emission dace can be easily made substantially the same.

Further, although the case where cold cathode fluorescent tubes are used has been described in the descriptions of the above first, second and fourth embodiments, the present invention is not limited to this, and other discharge fluorescence tubes such as hot cathode fluorescent tubes or xenon fluorescence tubes can also be used.

Note that in the case where discharge fluorescence tubes that do not contain mercury such as the above xenon fluorescence tubes are used, a long-life illuminating device that has discharge tubes arranged in parallel to the direction in which gravity acts can be constituted.

Further, although the configuration in which U tubes are used each having a pair of straight tube portions parallel to each other and a bent portion provided between these straight tube portions has been described in the description of the above third embodiment, the present invention is not limited to this, and it is also possible to use pseudo U tubes each having a pair of straight tube portions electrically connected by a connecting member provided outside, square-cornered U tubes each having a bent portion that is bent substantially 90° relative to a pair of straight tube portions and constituted into a square-cornered U shape, or discharge fluorescence tubes each having three or more straight tube portions provided in parallel to each other.

Further, the case where the first discharge tubes and the second discharge tubes are installed so as to be orthogonal to each other has been described in the description of the above fourth embodiment, the present invention is not limited to this, and may be applied to a device in which the first to Nth discharge tubes are installed so as to intersect each other.

However, as in the above fourth embodiment, in the case where the first and second discharge tubes are provided with respect to the light-emitting face, the case where these first and second discharge tubes are installed so as to be orthogonal to each other is more preferable in that it is possible to more easily and more reliably prevent luminance unevenness from appearing on the light-emitting face, and thus light-emitting quality can be most easily improved.

Further, although the case where so-called single-side drive is performed in which an inverter circuit is provided on one end portion side of the cold cathode fluorescent tube, and power is supplied to that cold cathode fluorescent tube from the end portion side has been described in the above description, the present invention is not limited to this, and the present invention is also applicable to the configuration in which an inverter circuit is also provided on the other end side, and two-side drive of the cold cathode fluorescent tube is performed.

In addition to the above description, the configuration using an appropriate combination of the first to fourth embodiments may be used.

### INDUSTRIAL APPLICABILITY

The present invention is useful for an illuminating device that can prevent a drop in light-emitting quality and a drop in the utilization efficiency of light from discharge tubes while achieving higher luminance, and a display device using the same.

1. An illuminating device including a light-emitting face for emitting light,
wherein first to Nth (N is an integer of two or more) discharge tubes sequentially provided in positions increasingly distant from the light-emitting face are installed, and
the first to Nth discharge tubes are set so as to have substantially the same light-emitting luminance as each other at the light-emitting face.

2. The illuminating device according to claim 1, wherein the first to Nth discharge tubes are set so as to have higher light-emitting luminance the further the distance from the light-emitting face.

3. The illuminating device according to claim 1or 2, wherein supply current to the first to Nth discharge tubes increases the further the distance from the light-emitting face.

4. The illuminating device according to claim 1, wherein a diameter of the first to Nth discharge tubes decreases the further the distance from the light-emitting face.

5. The illuminating device according to claim 1, wherein each of the first to Nth discharge tubes includes a plurality of discharge tubes that are provided on the same plane with a predetermined separation dimension therebetween.

6. The illuminating device according to claim 1, wherein each of the first to Nth discharge tubes includes a discharge tube having a plurality of straight tube portions that are linearly formed and provided in parallel to each other, and a bent portion that is provided so as to be continuous with the straight tube portions and bent relative to the straight tube portions.

7. The illuminating device according to claim 1, wherein the first to Nth discharge tubes are installed so as to intersect each other.

8. The illuminating device according to claim 1, comprising a diffusion plate that is provided above the first to Nth discharge tubes and diffuses light from the first to Nth discharge tubes,
wherein the light-emitting face is constituted by a light-emitting face of the diffusion plate.

9. A display device using the illuminating device according to claim 1.
